(19) United States
(12) Patent Application Publication
(10) Pub. No.: US 2017/0024586 A1
(43) Pub. Date: Jan. 26, 2017

(54) Device and Method for Transmitting Data

(71) Applicant: AVL LIST GMBH, Graz (AT)

(72) Inventor: Andreas Aldrian, Lieboch (AT)

(73) Assignee: AVL LIST GMBH, Graz (AT)

(21) Appl. No.: 15/302,343

(22) PCT Filed: Apr. 9, 2015
(86) PCT No.: PCT/EP2015/057683

§ 371 Date: Oct. 6, 2016

(30) Foreign Application Priority Data
Apr. 11, 2014 (AT) A 50275/2014

(51) Int. Cl. G06F 21/78; H04L 29/06

(52) U.S. Cl. CPC G06F 21/78; H04L 63/04; H04L 67/10

(57) ABSTRACT

The invention relates to a device (1) for transmitting data between at least one data-generating unit (2a-2f) and a remote communication unit (5a-5c). The device (1) has at least one interface (6a-6d) for an internet-based communication protocol to communicate securely with the remote communication unit (5a-5c) via a non-proprietary, preferably publicly accessible network (7), and at least one interface (8a-8i) for a communication protocol that is close to the hardware to communicate with the data-generating unit (2a-2f). The device also has a security controller (9) which is able to control communications via the internet-based interface(s) (6a-6d) and via the interfaces (8a-8i) that are close to the hardware, whereby a secure memory (10) with defined memory areas (A, B, C, D) is allocated to the security controller (9). At least one certificate (a, b, c) is assigned to at least one memory area (A, B, C, D).

The invention relates to a device for transmitting data between at least one data-generating unit and a remote communication unit, whereby the device has at least one interface for an internet-based communication protocol to communicate securely with the remote communication unit via a non-proprietary, preferably publicly accessible network, and at least one interface for a communication protocol that is close to the hardware to communicate with the data-generating unit. The invention also relates to a method for transmitting data between such a device and a remote communication unit.

The technical developments in communication technology are enabling an increasing number of services which until recently were not possible, because now more and more technological objects are able to transmit data via the internet and, for example, receive control commands remotely via the internet. Examples of this include controlling heating systems remotely from a smartphone or, in the industrial sector, the monitoring and remote maintenance of products.

An important field of these new strategies is known as “Smart Services”, which denotes services that are performed on a client's devices and facilities by a manufacturer or service provider via the internet. However, there is a problem with this in that the prerequisites for such services often still need to be created, because the necessary service-oriented architecture (SOA) is not yet available.

One prerequisite for implementing service-oriented architecture is that all the devices involved must in some way be capable of internet-based communication. In the context of the subject matter of the application, “internet-based” protocols are considered to be those which allow a secure, preferably AAA-compliant communications link, which can be encrypted, to be established via open networks, i.e. networks accessible to third parties, in particular the internet, and allow data traffic to be processed through it. The protocol stack of an internet-based protocol depicts all 7 layers of the OSI reference model.

The communications link here is generally established via a web service. A web service is distinguished in particular by its type of connection set-up. Here, communication is established from the remote communications unit which seeks to retrieve data from the endpoint device. For this, it is essential that the ports for incoming communication are open in the security architecture at the endpoint device, via which a tunnel can be established from the remote communication unit to the endpoint device. These open ports and the ability to remotely initiate a data request present a potential security risk and are therefore exploited for hacker attacks.

In order to make such a connection more secure, certificates are used which are saved on the endpoint device and via these, the identity of the device making the request can be assured and an encrypted connection can be established. However, in order to establish the secure connection, a connection must first be made between the remote communication unit and the endpoint device, which in turn provides opportunities for attacks.

Highly complex industrial systems, for example for production or carrying out tests, generally comprise devices from multiple manufacturers, whereby several specialists are responsible for the maintenance of the individual components. For the manufacturers of such components, it is of great interest to receive information about the use of their products from customers, partly to obtain data for further development, but also to be able to provide suitable maintenance and service strategies, which is also beneficial for the customer.

In industrial environments above all, there are three main groups of problems which slow down implementation:

Firstly, in contrast to consumer products such as smartphones, many components in industrial systems are very specifically determined for their respective applications, and often only have a very limited communication ability, from a simple, wired, analogue signal output, to fieldbuses such as CAN or Profibus, right through to simple network systems such as Ethernet. With regards to the OSI layer model, such communication protocols that are close to the hardware are mostly allocated to layers 1, 2 and 3. These types of connection solutions are only suitable for local networks and they lack security systems. For these types of systems, a connection to the internet would only be possible via gateways, but this would expose the system to an enormous risk of attack, in particular if third parties, e.g. a service provider, is granted access to the system's data. These types of systems are therefore only used in isolation and this isolated architecture rules out the possibility of integrating service-oriented architecture.

Secondly, the systems are usually evolved systems in which components have been used together for several generations. Due to the long life of industrial components, these can often have been in use for decades. However, exchanging all components in a system with “web-enabled” devices at the same time is usually out of the question and would raise further security issues.

Thirdly, the system data is often highly sensitive and must be kept secret from competitors, and often should also not be disclosed to the manufacturers of the systems or to service providers. It is extremely important for companies that they can decide on the use of their data at any time. For obvious data security reasons, communication systems which are created for consumers are therefore usually out of the question for industrial purposes.

This invention aims to overcome the disadvantages of prior art. In particular, it should also be possible to integrate devices that can only communicate via a communication protocol that is close to the hardware into a service-oriented architecture. Nevertheless, it must be possible to eliminate the possibility of these devices being accessed by unauthorised persons. According to the invention, it should also be possible to integrate old, existing devices that are still in use into the service-oriented architecture. As a further security requirement, according to the invention it should be possible to specifically determine the data access permissions for all those involved in a simple, comprehensible manner.

In the context of this description, “communication protocols that are close to the hardware” denote general communication protocols with a layer construction or protocol stack which does not cover all 7 layers of the OSI model, in particular protocols which have no presentation layer (layer 6), and therefore do not allow communication across the whole system or data encryption. A feature of communication protocols that are close to the hardware is that they do not enable any implementation of security protocols that would allow for reliable, secure communication via shared (cloud) networks.

Existing communication interfaces for protocols that are close to the hardware, which can use, for example, fieldbus technology or a point-to-point Ethernet connection, are therefore limited to the mere minimum of 7 layers of the OSI model. Particularly simple communication protocols that are close to the hardware only use the bit-transfer layer (layer 1) or a combination of the bit-transfer layer and the security layer (layer 2).

Examples of protocols for the bit-transfer layer are V.24, V.28, X.21, RS 232, RS 422, RS 423 or RS 499. Examples that use a combination of layers 1 and 2, or just layer 2, include the Ethernet protocol, HDLC, SDLC, DDCMP, IEEE 802.2 (LLC), ARP, RARP, STP, IEEE 802.11 (WLAN), IEEE 802.4 (Token Bus), IEEE 802.5 (Token Ring) or FDDI.

In communication protocols that are close to the hardware, protocols of higher layers can also be used. Examples of protocols of layers 5 to 5 include X.25, ISO 8208, ISO 8473 (CLNP), ISO 9542 (ESIS), IP, IPsec, ICMP, ISO 8073/X.224, ISO 8602, TCP, UDP, SCTP, ISO 8326/X.215 (Session Service), ISO 8327/X.225 (Connection-Oriented Session Protocol) or ISO 9548 (Connectionless Session Protocol).

Examples of communication protocols that are close to the hardware which are particularly used for industrial applications in the field of test environments, for example in the automobile industry, include, among others, the AK protocol via RS232, CANopen via CAN and Profibus-DP via RS485. The AK protocol of the German Automobile Industry Association/Working Group of Engineers for the Standardisation of Exhaust Fume Measurement (“Verband der Automobilindustrie e.V./Arbeitskreis Techniken zur Standardisierung der Abgasmessung”) in particular is still a de facto standard at many test facilities in the automobile industry. It was created as a simple protocol for data transfer close to the hardware and does not offer any possibility to implement a triple A system (Authentication, Authorisation, Accounting—AAA).

According to the invention, the objectives outlined above are achieved by means of a device of the type mentioned at the beginning, which has a security controller that is able to control communications via the internet-based interface(s) and via the interfaces that are close to the hardware, whereby a secure memory with defined memory areas is allocated to the security controller, whereby at least one certificate is assigned to at least one memory area. This type of device can communicate with the data-generating unit via the interface that is close to the hardware, i.e. in particular with individual components of the system that is to be integrated into the service-oriented architecture, via its communication protocol that is close to the hardware, and generate the relevant data, which is stored in a specific memory area. In order to request the data, a remote request can be carried out from the remote communication unit, via the internet-based interface, whereby permission for the retrieval can be checked via the certificate. For each memory area, the respective authorised access certificates (or the “certified” subjects which possess this certificate) are determined individually. The security controller ensures that the communication link (the so-called “tunnel”) ends in the security controller and that it is not possible for any remote communication unit to establish a direct connection with the endpoint device (i.e. the data-generating unit). Therefore, the relevant certificates are also stored in the secure memory of the security controller and not in the memory of the data-generating unit.

In general, a certificate denotes an object via which the it can be ensured that a person or instance can be trusted and indisputably identified. The refers in particular to the authentication and authorisation steps of the so-called AAA compliance. Certificates can be used in particular for safeguarding transport and access. Here, the public part of the certificate (“Public Key”) is used for safeguarding, so that only the owner of the relevant private part of the certificate (“Private Key”) is able to access or view the data. The standard which is currently the most widespread is X.509, also known as “PKI Store”, however other usable procedures are also known to a person skilled in the art.

In an advantageous method, at least one memory area can contain program code which can be executed on the security controller. In this way, the parts of the program relating to security, which for example define the operations of the security controller, are protected against manipulation in the secure memory and they also provide access control via certificates.

In an advantageous method, the memory area which contains the program code can be assigned to the certificate of a security controller's hardware supplier. Fundamental parts of the program can therefore only be modified by the security chip hardware supplier themselves, eliminating the possibility of security features being accidentally deactivated by employees or deliberately damaged by attackers.

An advantageous embodiment of the invention can ensure that at least one memory area is allocated to a specific data-generating unit, whereby the memory area contains a unique ID, operating data, control data, configuration data and/or historical data from the unit. In this way, it is possible, for example, for the service provider to access the relevant data via remote access and also modify it depending on access permissions (e.g. in order to re-set them after completing a service). With several memory areas being allocated to an individual unit, complex permissions structures can also be implemented by allocating different certificates. Because the communication link ends in the security controller, it is impossible for the remote communication unit to communicate with the data-generating unit or manipulate the data-generating unit.

Another advantageous embodiment of the invention ensures that at least one memory area contains certificates and/or allocations. This means that the certificates themselves are also protected against external access by means of the same system. Furthermore, it can be determined who is allowed to change the allocations and therefore the certified people. Here, it can be particularly advantageous if the memory area which contains the certificates and/or allocations is assigned to the certificate of one of the owners of the device. This is often sensible, because it means that the owner themselves can define which rights are given to third parties, in particular to service providers. A particularly high level of security is achieved when the access permissions are defined in the program code of the security controller.

In an advantageous method, the security controller can have a means to monitor data-generating units which are connected to the interfaces close to the hardware. In this way, it will be noticed if a device, for example, is replaced without being authorised and if the device data is plausible, for example whether an operating hours meter is increasing in a strictly monotone manner.

In a preferred embodiment, the security controller can be integrated into a hardware chip. This prevents the manipulation of programs carried out by the security controller.

In order to protect the security controller against attacks as well, the hardware chip can comprise a secure memory and an integrated CPU in an advantageous method.

In an advantageous embodiment, the hardware chip can contain a crypto module. The crypto module controls the encryption of the communication. With the crypto module being integrated in the hardware chip, attacks which aim to disrupt the encryption process are avoided.

With the combination of a secure memory, a CPU and a crypto module integrated into a security controller, which is integrated into a hardware chip, the security controller is able not only to manage the secure memory, but also securely carry out computing operations itself. This has the advantage that the security controller functions “self-sufficiently” and is not dependent on a vulnerable CPU. Here, the security controller can include parts of the program that are hardware-coded which cannot be manipulated via data-based attacks.

In the context of this description, secure memory refers to memory which is protected against unauthorised access. In particular, this can be memory to which only the security controller has access, and which therefore cannot be manipulated by third parties.

In an advantageous method, by using the device, a procedure for transmitting data between the device and a remote communication device is carried out, which is characterized by the following steps: Establishing a communication link via an internet-based interface with a communication unit belonging to a certified person, to which a certificate has been allocated; identifying the certificate of the certified person; identifying a memory area for the data to be transmitted; checking the allocation of the certified person's certificate to the memory area, and if the check gives a positive result, transmitting the data saved in the memory area to the remote communication unit and/or receiving data from the remote communication unit and saving the received data in the memory area. By means of this procedure, complex security architectures can be implemented simply and practically.

In an advantageous method, the procedure can also have the following steps: Receiving or requesting (operational) data from a unit via an interface that is close to the hardware; and saving the operational data in a secure memory area allocated to the unit. In this way, the (operational) data of the units can be requested either based on a schedule, by a specific incident or based on a user request from the device. In a subsequent remote request, there is then no further access required to the unit itself, because the data is already stored in its secure memory. According to the invention, it is therefore not necessary for the certified person to directly access the unit themselves to request the data. This securely avoids manipulations of the systems that are located in the unit.

In a particularly preferable embodiment, the device's communication with the remote communication unit can be encrypted. Because the respective communication partner is identified by means of the certificate, the encryption can simply be done via key pairs which are allocated to the certificates.

In an advantageous method, a protocol can be implemented in the internet-based interface, which function purely via push mechanisms. These types of protocols, for example according to the MQTT specification, allow firewall rules to be implemented in the internet-based interface, which block incoming traffic. This eliminates the possibility of the system being manipulated via web services and an end-to-end connection being established with the endpoint data-generating unit. For protocols which function purely via push mechanisms, for example those according to the MQTT protocol, it is known that no direct end-to-end connection is established, but rather the communication is always transmitted via an intermediary broker, which contains data from a “publisher” and supplies it to one or more “subscribers”, whereby the publisher and/or subscriber can be identified by means of a certificate. Each endpoint “opens” the communication with the broker by itself, and this is not initiated “from the outside”. Because both communication partners can act as both a subscriber and a publisher, it is also possible to exchange data in both directions without the need for a potentially vulnerable web service to be created.

The security controller also establishes a connection with the broker at set intervals, and the requested data is either supplied by an authorised third party (i.e. the device acts as the publisher), or data is requested by a third party (i.e. the device acts as a subscriber).

The invention is described in detail below with reference to the attached drawings, whereby:

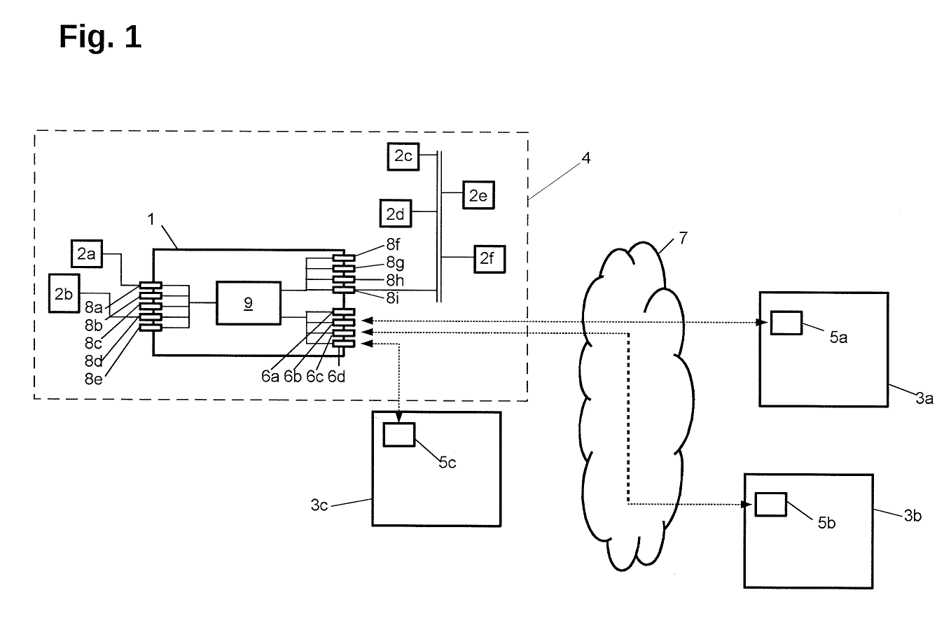

FIG. 1 depicts a schematic diagram of network components with which the inventive device communicates;

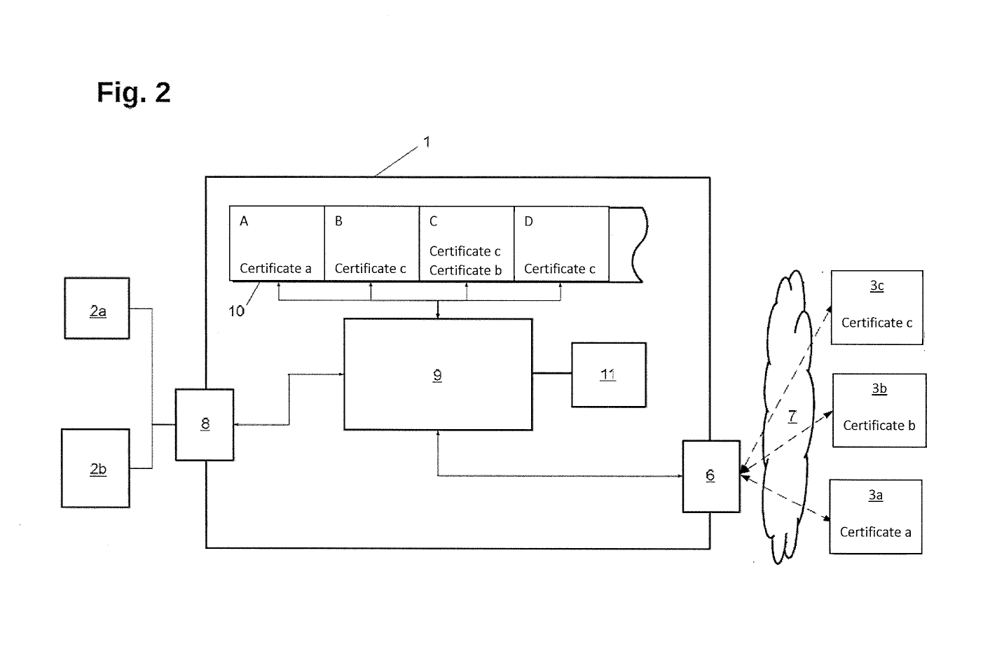

FIG. 2 depicts a schematic diagram of the essential elements of the inventive device;

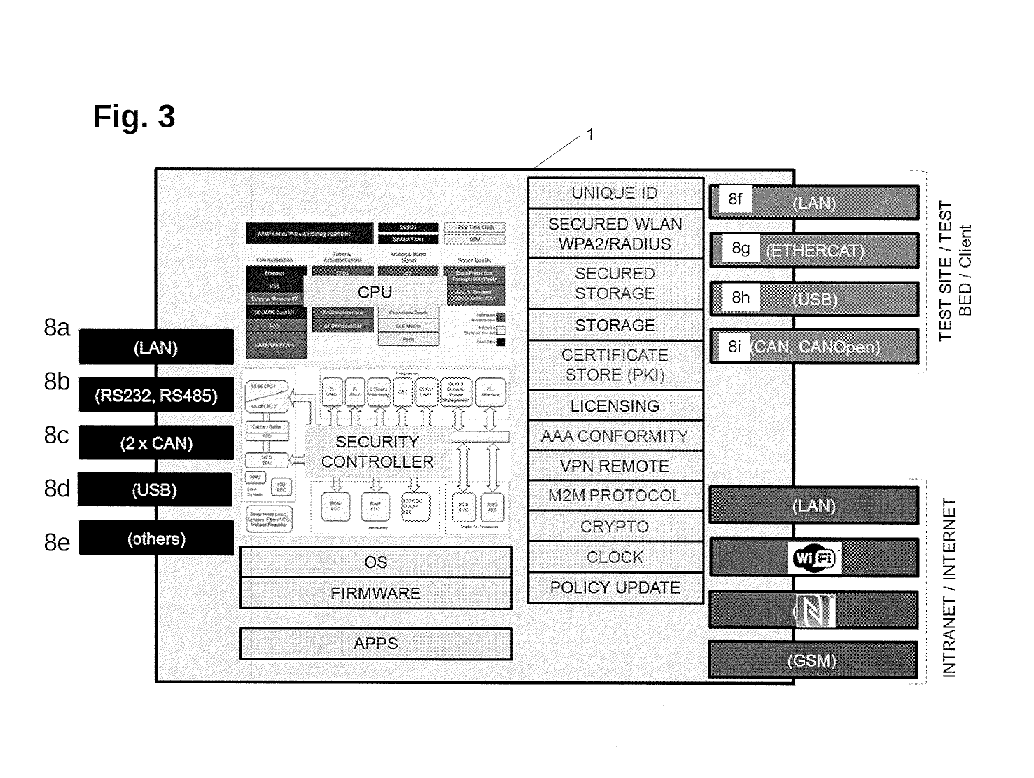

FIG. 3 depicts another schematic diagram of the inventive device to clarify examples of communication protocols; and

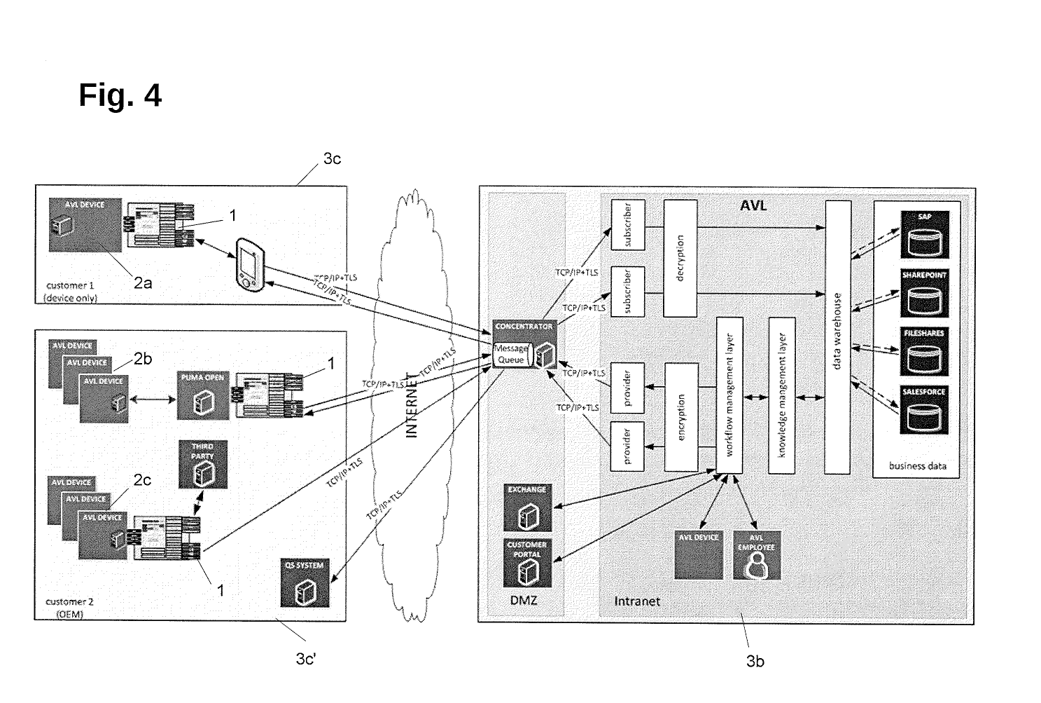

FIG. 4 depicts a schematic diagram of a network with service-oriented architecture in which the inventive device is used in several places.

FIG. 1 depicts an example network layout which can essentially be divided into five areas, namely the industrial site area (4), the three areas 3a, 3b and 3c, hereinafter referred to as “certified” communication participants, namely a hardware supplier (3a), a service provider (3b), and an owner (3c), each with a respective remote communication unit (5a, 5b, 5c), and the non-proprietary network area (7), which has cloud infrastructure, in particular the internet.

The industrial site (4) can, for example, be a production factory or a testing facility, e.g. for the automobile industry, whereby the site is assigned to a specific owner (3c). The owner of the industrial site (4) is of particular importance because he or she must determine the access permissions, as detailed below. At the industrial site (4), there are a large number of data-generating units (2a to 2f), whereby “data-generating units” are essentially considered to be all devices with a status that can be monitored in some way. In particular, there can be units which come from a certain supplier who is interested in monitoring the products that have been bought from them in order to be able to plan ahead and provide any possible services quickly and straightforwardly. In FIG. 1, the service provider has their own area (3b) assigned to them.

An inventive device (1) is provided for the industrial site (4), whereby the device (1) has several interfaces that are close to the hardware (8a-8i), which are connected to the data-generating units (2a-2f) in different ways. The data-generating units (2a-2f) can be arranged in several groups, whereby in the presented arrangement the units 2c-2f form one group which is connected to a joint fieldbus via which the units communicate, whereby any one of the communication protocols known in the field for fieldbus systems can be used, for example CANopen or Profibus DP. The device (1) is also connected to the fieldbus via interface 8i in order to be able to communicate with units 2c-2f in the group. Another group is formed of the units 2a and 2b, which are each connected to interface 8b, 8d and device 1 respectively via an end-to-end protocol.

It should be noted that the units generally do not have any means to transmit over the internet via internet-based protocols. However, it can be the case that despite a unit's ability for internet-based communication in principle, it is not permitted for this unit to be connected to an open network because there are other units in the network that could be exposed to unauthorised access through this action.

The hardware supplier of device 1, or the hardware supplier of the security elements of device 1, in particular the supplier of the security controller (9) contained within the device, has another area (3a) assigned to it. In the context of this description, the term “hardware supplier” refers particularly to the actual chip manufacturer, or even a third party supplier, for example a certification authority. The term “hardware supplier” refers in particular to the body that is responsible for the functionality and the development of the security controller. A special security feature of the device can ensure that the security controller's underlying program code can only be updated by the body that is named as the hardware supplier and, if necessary, under special safety precautions.

The device (1) in FIG. 1 has several internet-based interfaces (6a-6d) via which communication can be established with other units across the whole system via open or proprietary networks such as an intranet, a GSM network and/or the internet. The establishment of internet-based connections, communication via these connections and the protocols used for this are all well known in the field and therefore do not require any further explanation. In the example embodiment presented in FIG. 1, device 1 communicates with a remote communication unit (5c) belonging to the owner (3c) of the industrial site (4) via an intranet connection, and with the remote communication units 5a and 5b of the service provider (3a) or the hardware supplier (3a) via an internet connection.

With regards to FIG. 2, this explains the functionality of the inventive device (1), whereby the function of the security controller (9) is explained in particular. The security controller (9) of device 1 can be constructed as an individual chip or as a combination of several chips, whereby the security controller works together with a microcontroller (11) (ARM-CPU). It is also possible to integrate the security controller (9) and the microcontroller (11) into one single chip. This enables an event higher level of security, however, it would also involve significant expenditure in terms of development.

The security controller controls the communication with the data-generating units 2a-2f via the interfaces that are close to the hardware (8a-8i), the communication via the internet-based interfaces (6a-6d), and access to the secure memory (10).

The secure memory (10) is isolated by the hardware in such a way that it can only be accessed by the security controller (9). In order to be able to use the device, it must first be “commissioned” by a generating unit, whereby in the case shown, the commissioning is carried out by the hardware supplier. For this commissioning, the storage (10) is specifically divided into individual memory areas A, B, C, D, etc., whereby the program code for controlling the security processor (9) is stored in the first memory area (A). Certificates a, b, c and d are stored in memory area B for all entities that are to be considered for access permission, whereby this is the public part of the certificate. As well as defining memory areas A, B, C and D, the program code also determines which certificate holder should have access to which memory areas, and whether the access permission should also allow the holder to modify data.

In the example shown, memory area A, in which the program code is stored, is secured by the hardware supplier's or commissioning entity's certificate. This means that the program code (and therefore the division of memory areas and the access permissions structure) can only be modified by hardware supplier 3a. Changes to the program code cannot be made by either the owner (3c) of the device or the service provider (3b), but only by the hardware supplier (3a), for example if an update needs to be made. If the program code requires an update, another security function can also ask for the owner's (3a) and/or service provider's (3b) consent.

In the embodiment described, each inventive device is therefore specifically adjusted to the respective operating conditions during commissioning, so that subsequent changes are either impossible or only possible to a limited extent. However, depending on the security conditions, subsequent changes may be allowed, but these possibilities must be defined in the program code. So, for example, an exchange of individual certificates could be allowed once they have expired and need to be renewed.

The other memory areas (C, D, etc.) are each assigned to a respective data-generating unit (2a-2f) or a group of such units, whereby the data stored in each respective memory area is also controlled by the program code. Data updates can either initiated by a specific incident (e.g. if the service provider (3b) re-sets the service indicator after maintenance), or they can be ongoing or triggered at specified time intervals (e.g. for recording operating times). The respective memory areas C and D can also contain a unique ID per unit for the units 2a-2f, as well as information about the communication protocol to be used.

Communication via the internet-based interfaces 6a-6d is also controlled by security controller 9, whereby each time a communication connection is established, the relevant certificate is checked and the communication link is also encrypted, preferably via the certificate, so that only the holder of the Private Key can access the content. This means that it can be precisely defined which memory areas a certificate holder is allowed to access. If necessary, the data in certain memory areas can also be stored in an encrypted form with a certificate. However, in this way, the content can only be accessed with one single certificate. In other cases, it is preferable for the data to be stored in a different way, for example with a symmetrical key, in an encrypted or unencrypted form in the memory, and not until the data transmission has been encrypted by the security controller with the relevant certificate.

In the embodiment depicted in FIG. 2, the owner (3c) with the certificate (3c) can access the memory areas B, C and D, the service provider (3b) can access memory area C with their certificate, and the hardware supplier (3a) can only access memory area A with their certificate.

The security controller (9) ensures that communication via the interfaces close to the hardware (8) is strictly separated from the communication via the internet-based interfaces (6), so that it is impossible to directly access the data-generating units 2a-2f via one of the internet-based interfaces. Even if an attacker manages to successfully bypass all security measures and hack into the security controller, it will still not be possible for them to gain access to the data-generating units, because these communicate on completely different protocol levels compared to those used for the communications protocols of the internet-based interfaces.

The security aspects of the devices and procedures of this invention can be adapted to individual user requirements as desired, whereby additional security measures can be implemented and certain security features can also be omitted.

FIG. 3 depicts another schematic diagram of an example embodiment of the inventive device, whereby the individual elements with regards to the functional components and the protocols used are divided up by way of example. The device in FIG. 3 has five interfaces close to the hardware for directly connecting units; these are the interfaces 8a (LAN), 8b (RS232 or RS485), 8c (CAN), 8d (USB) and 8e (other). The other interfaces that are close to the hardware are the interfaces 8f (LAN), 8g (Ethercat), 8h (USB) and 8i (CAN, CANOpen).

FIG. 4 depicts a schematic diagram of a network with service-oriented architecture from service provider 3b, whereby the inventive device (1) is used at the premises of several of the service provider's customers (owners 3c and 3c′) in order to enable access to data on the customer's data-generating units 2a-2c, which are serviced by the service provider (3b), in such a way that access permissions can be defined by each respective owner.

### LIST OF REFERENCE NUMBERS

Device (1)
Data-generating unit (2a-2f)
Certified person (3)
Hardware supplier (3a)
Service provider (3b)
Owner (3c)
Industrial site 4
Remote communication unit (5a-5c)
Internet-based interface (6a-6d)
Non-proprietary network (7)
Interfaces that are close to the hardware (8a-8i)
Security controller (9)
Secure memory (10)
Microcontroller 11
Memory areas (A, B, C, D)
Certificates a, b, c

1-14. (canceled)

15. A device (1) for transmitting data between at least one data-generating unit (2a-2f) and a remote communication unit (5a-5c), whereby the device (1) has at least one interface (6a-6d) for an internet-based communication protocol to communicate securely with the remote communication unit (5a-5c) via a non-proprietary, preferably publicly accessible network (7), and at least one interface (8a-8i) for a communication protocol that is close to the hardware to communicate with the data-generating unit (2a-2f), wherein the at least one data-generating unit (2a-2f) is a component of an industrial system which only communicates via the communication protocol that is close to the hardware to transmit data, whereby the device also has a security controller (9) which controls the communications via the internet-based interface(s) (6a-6d) and via the interfaces (8a-8i) that are close to the hardware, whereby a secure memory (10) with defined memory areas (A, B, C, D) is allocated to the security controller (9), whereby at least one certificate (a, b, c) is assigned to at least one memory area (A, B, C, D).

16. The device according to claim 15, wherein at least one memory area (A) contains program code which can be executed by the security controller (9).

17. The device according to claim 16, wherein the memory area (A) which contains the program code is assigned to the certificate (a) of a hardware supplier (3a) of the security controller.

18. The device according to claim 15, wherein at least one memory area (C, D) is allocated to a specific data-generating unit (2a, 3b), whereby the memory area contains a unique ID, operational data, control data, configuration data and/or historical data from the unit.

19. The device according claim 15, wherein at least one memory area (B) contains certificates (a, b, c) and/or allocations.

20. The device according to claim 19, wherein the memory area (B) which contains the certificates and/or the allocations is assigned to the certificate (c) of an owner (3c) of the device (1).

21. The device according to claim 15, wherein the security controller (9) has a means to monitor the data-generating units (2a-2f) which are connected to the interfaces (8a-8i) that are close to the hardware.

22. The device according to claim 15, wherein the security controller (9) is integrated in a hardware chip.

23. The device according to claim 22, wherein the hardware chip comprises a secure memory and an integrated CPU.

24. The device according to claim 22, wherein the hardware chip contains a crypto module.

25. The device according to claim 15, wherein a protocol is implemented in the internet-based interface which functions purely via push mechanisms.

26. A method for transmitting data between a device according to claim 15, and a remote communication unit (5a-5c), wherein the method has the following steps:
establishing a communications link via an internet-based interface (6) with the communications unit (5a-5c) of a certified person (3) who has a certificate (a, b, c) assigned to them;
identifying the certificate (a, b, c) of the certified person (3);
identifying a memory area (A, B, C, D) for the data to be transmitted;
checking the allocation of the certificate (a, b, c) belonging to the certified person (3) to the memory area (A, B, C, D), and
if the check gives a positive result, transmitting the data saved in the memory area (A, B, C, D) to the remote communication unit (5a-5c) and/or receiving data from the remote communication unit (5a-5c) and saving the received data in the memory area.

27. The method according to claim 26, including the following steps:
receiving or requesting (operational) data from a unit (2a-2f) via an interface (8) that is close to the hardware; and
saving the operational data in a secure memory (10) area (B, C, . . . ) allocated to the unit (2a-2f).

28. The method according to claim 26, wherein the communication with the remote communication unit (5a-5c) takes place in an encrypted form.

29. The method according to claim 26, wherein a protocol is implemented in the internet-based interface which functions purely via push mechanisms.
